(19) United States
(12) Patent Application Publication
(10) Pub. No.: US 2003/0048591 A1
(43) Pub. Date: Mar. 13, 2003

(54) Desmearing process/apparatus for pulse-type D.C. plasma

(75) Inventors: Robert Jann, Taoyuan Hsien (TW); Shyh-Horng Sheu, Taipei (TW); Hsuch Liang Liao, Shin-Chu City (TW)

Correspondence Address: DOUGHERTY & TROXELL, SUITE 1404, 5205 LEESBURG PIKE, FALLS CHURCH, VA, 22041, US

(73) Assignee: Saturn Vac Co., Ltd.

(21) Appl. No.: 09/948,590

(22) Filed: Sep. 10, 2001

(51) Int. Cl. H01T 23/00

(52) U.S. Cl. 361/230

(57) ABSTRACT

A method for desmearing pulse-type D.C. plasma and an apparatus for the method, the apparatus has a vacuum chamber for a vacuum pumping system to make the chamber a vacuum state. An electrode holder is provided in the vacuum chamber for a plurality of electrode plates separately mounted thereon in a line. The electrode plates use a pulse-type D.C. power supply as a source of energy for excitation of plasma. An electrode plate to be processed is located between every two electrode plates in a state of floating. A gas inlet system is provided in order that the aforesaid vacuum pumping and excitation of plasma can cooperatively make uniform distribution of reaction gas in the vacuum chamber to shorten the process flow and the operation time of desmearing in the holes of a printed circuit board and to lower the cost of equipment.

### BACKGROUND OF THE INVENTION

1. Field of the Invention

The present invention is related to a method for desmearing pulse-type D.C. plasma and an apparatus for the method, and especially to such a method capable of reducing processing time and requiring smaller investment of apparatus for the process of desmearing for holes on a printed circuit board.

2. Description of the Prior Art

A multiple-layer printed circuit board used nowadays has each layer thereon connected mainly by surface copper plating on through holes, blind holes and buried holes in the circuit board as its conducting paths, thereby, it needs to be processed by drilling in advance. While hole desmearing on the printed circuit board always has been being the most important matter in the processing of such a printed circuit board.

As shown in FIGS. 1 and 2, a printed circuit board (PCB) 10 generally used is drilled with a laser or mechanical drill 11. Wherein, the PCB 10 is made of copper wires 12 and resin (such as epoxy or polyimide) printed on the surface. The resin will be heated during laser or mechanical drilling, holes 11 after drilling will produce smear 13 (or rough edges, carbon dregs). And referring to FIG. 3, a layer of copper 15 is plated on a hole 11, it is subjected to inferior connecting and stripping off by the presence of the smear 13, and thereby, signal transmitting on lines from the PCB 10 is inferior.

Conventional methods for desmearing are processed by using potassium permanganate (KMnO₇) or sodium permanganate (NaMnO₇), their corrosion speeds are slow, and there is environmental problem in dealing with waste water; in view that PCBs produced will be more and more smaller, i.e., from 15 μm to 5 μm, water solution of potassium permanganate or sodium permanganate in the wet process will be very hard to penetrate into the holes for desmearing, not mentioning those blind holes and buried holes.

To solve the difficulty of desmearing in small holes, some dealt with the smear in the small holes with ionized gaseous plasma. It was studied and testified that, the plasma technique can be used to deal with the smear in the small holes. However, prior related inventions all use high radio frequency (RF, 13,56 MHz) or microwave (2.45 GHz) as the energy source of excitation of plasma. The ionized molecules or atoms are generated by the high frequency power; the plasma density is around 10⁸˜10¹⁰/cm³; and then by control of the direction of gas flowing to lead or diffuse the gas to the small holes, the ionized gas will be attached by adsorption on the smear to induce chemical reaction, thus the smear is removed. However practically, the smaller the diameters of the holes become, the more difficult the molecules of gas are to enter the small holes smoothly; the mean free path of the molecules of gas must be increased if the diameters of the holes get smaller, and the pressure for reaction in the plasma system must be lowered. In pursuance of the requirement of lowering the pressure, pumping speed must be increased, even it is required that a turbo pump or a diffusion pump shall be added to the system. This not only increases the time for the whole operation, even the cost of apparatus for the system may be increased in order to effectively etch the smear. Lowering of the pressure may effectively desmear in the small holes, however, lowering of the pressure will reduce the number of the molecules of gas in the reaction, and also reduce the concentration of the reaction, and the speed of desmearing will be decreased, mass production ability in industrial application thus is doubtful.

### SUMMARY OF THE INVENTION

The object of the present invention is to provide a method for desmearing pulse-type D.C. plasma and an apparatus for the method, wherein, a pulse-type D.C. power supply is used as a source of excitation of plasma in order to shorten the process flow and the operation time of smear desmearing on a printed circuit board and to effectively reduce the investment on the apparatus.

The smear desmearing method of the present invention include the following steps:

place a circuit board to be processed in a vacuum chamber;

the vacuum chamber is pumped to get a predetermined base pressure;

feed in reaction gas;

supply pulse-type D.C. power energy for the electrode plates, an electric field is generated between the positive and the negative plates, and the ionized gas of plasma will be controlled by the electric field;

control the conditions for the process;

the reaction is completed;

shut off the energy and reacting gas;

once more pump down and remove the residual gas from the vacuum chamber.

In an embodiment of the present invention, there is a vacuum chamber of which a front access is controlled for opening/shutting with a movable door, and an electrode holder is provided in the vacuum chamber for mounting a plurality of mutually separated electrode plates. A pumping system is provided to exhaust gas by means of two pumping ports symmetrically allocated and an array pumping plate, and pumping is done in the vacuum chamber by aiding of a gasway device to feed in the reacting gas. A sample holder is provided to position a printed circuit board thereon by clamping or inserting, and is pushed into the vacuum chamber to have each PCB being processed located between two electrode plates. The electrode plates has a pulse-type D.C. power source to generate the plasma to desmear in the holes on a printed circuit board.

The present invention will be apparent in its novelty and features after reading the detailed description of the preferred embodiment thereof in reference to the accompanying drawings.

### BRIEF DESCRIPTION OF THE DRAWINGS

FIG. 1 is a plane view showing a conventional electric circuit board;

FIG. 2 is a sectional view taken from the section line 2-2 in FIG. 1;

FIG. 3 is a sectional view as that of FIG. 2 showing a hole is plated with copper;

FIG. 4 is a perspective view showing a preferred embodiment of the main processing apparatus of the present invention;

FIG. 5 is a perspective view as FIG. 4, showing a door is moved down for opening;

FIG. 6 is an exploded perspective view as FIG. 5 showing a part of a vacuum chamber;

FIG. 7 is an exploded top view as FIG. 5 showing a part of the vacuum chamber;

FIG. 8 is a schematic perspective view as FIG. 5, showing the related positions of the members when a wheeled device moves into/out of the sample holder;

FIG. 9 is a side view taken from FIG. 8;

FIG. 10 is a perspective view showing an array pumping plate with a lot of holes of the present invention;

FIG. 11 is an analytic perspective view showing the structure of electrode plates of the present invention;

FIG. 12 is a perspective view showing the structural relationship among an electrode holder, the electrode plates and the sample holder of the present invention;

FIG. 13 is a perspective view showing a gasway device of a pumping system of the present invention;

FIG. 14 is a front view taken from FIG. 13;

FIG. 15 is a sectional side view taken from FIG. 14;

FIG. 16 is a perspective view showing another preferred embodiment of sample holder of the present invention;

FIG. 17 is an enlarged perspective view showing the wheeled device as shown in FIG. 8 of the present invention;

FIG. 18 is an enlarged perspective view showing the panel as shown in FIG. 17;

FIG. 19 is a bottom view taken from FIG. 18;

FIG. 20 is a perspective view showing another preferred embodiment as that in FIG. 4 added with a related accessory of the present invention;

FIG. 21 is a front view taken from FIG. 20;

FIG. 22 is a side view taken from FIG. 20; and

FIG. 23 is a top view taken from FIG. 20, showing the major elements in the vacuum chamber of the present invention.

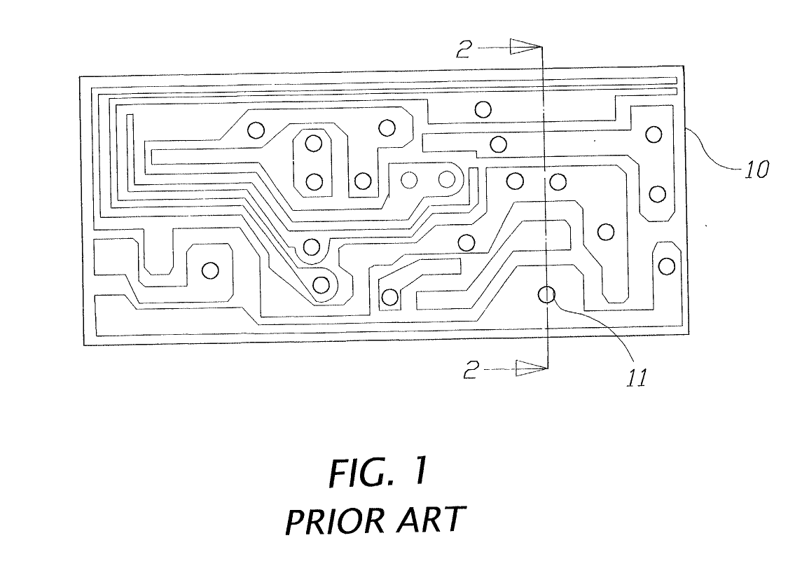

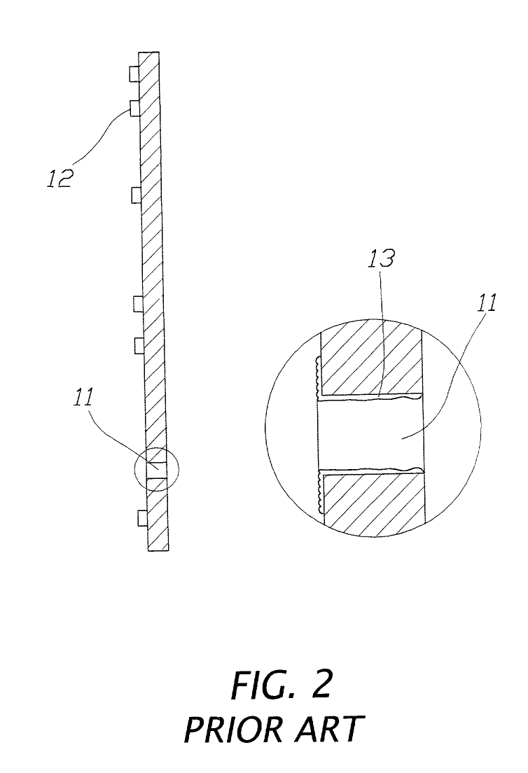

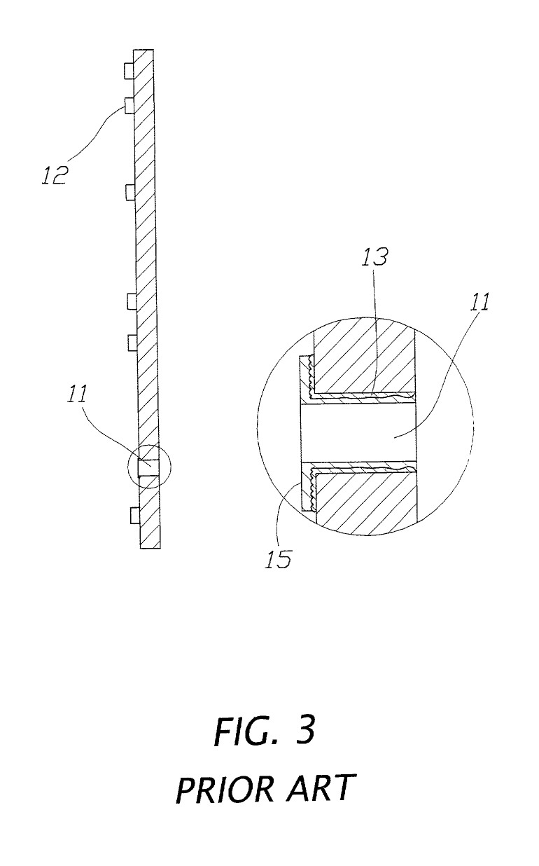

### DETAILED DESCRIPTION OF THE PREFERRED EMBODIMENT

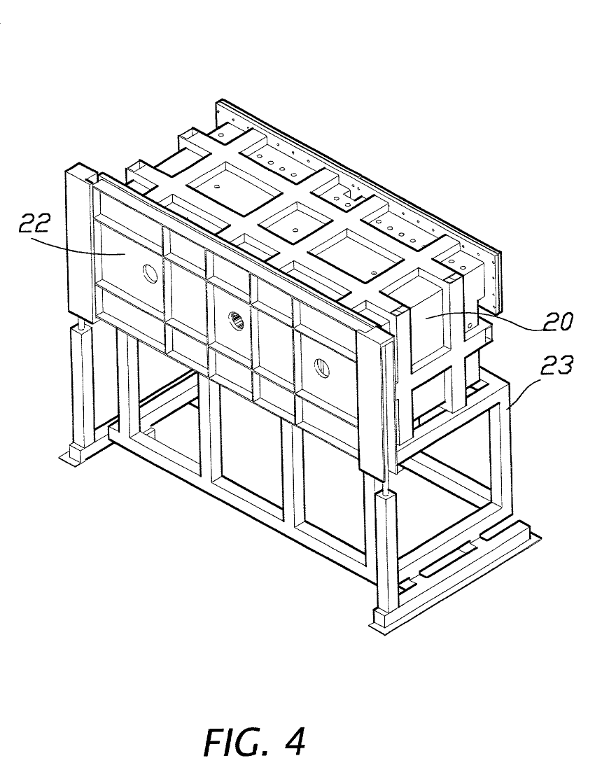

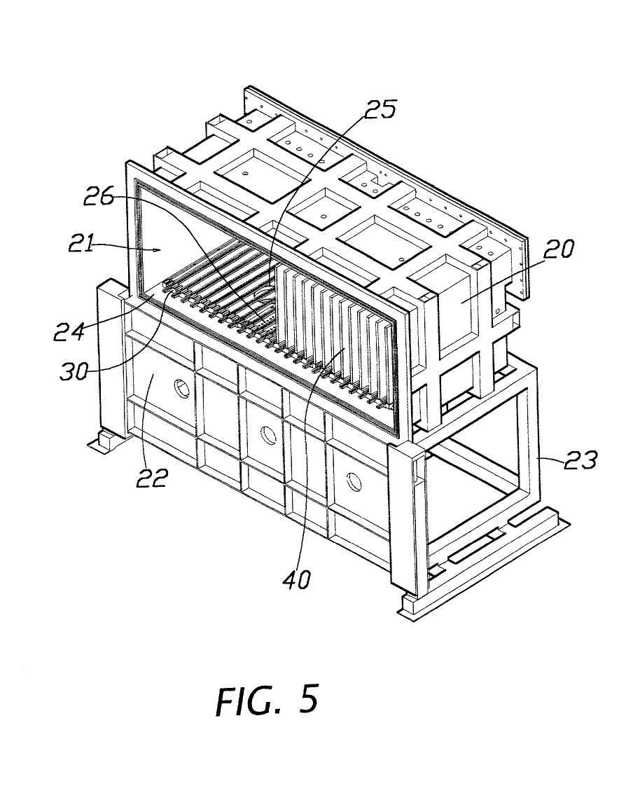

Referring to FIGS. 4, 5, the present invention is provided with a vacuum chamber 20 suitable for mass production. The vacuum chamber 20 has all its sides sealed except a front access 21; a movable door 22 is provided at the front access 21 as a control member for opening/shutting the vacuum chamber 20. By virtue that the vacuum chamber 20 must be of a larger volume for mass production, in the embodiment shown, the vacuum chamber 20 in the preferred embodiment shown in the drawings is mounted at a location of suitable height by means of a stand 23. The door 22 is provided to be under a mode of two-stage oil pressure control, it is shut when it is at an upper position, and can open the access 21 of the vacuum chamber 20 when it is moved down. The first stage of the two-stage oil pressure control is to control the up/down movement of the vacuum chamber 20; the second stage of the two-stage oil pressure control is to control the frontward/rearward movement of the door 22. In operation, the door 22 moves up and down linearly, when it moves to the top and is positioned there, it is moved rearwardly toward the access 21 of the vacuum chamber 20 to be tightly close to the access 21 of the vacuum chamber 20. Contrarily, when in opening the door 22, it is pushed forwardly away from the vacuum chamber 20, and then is moved down.

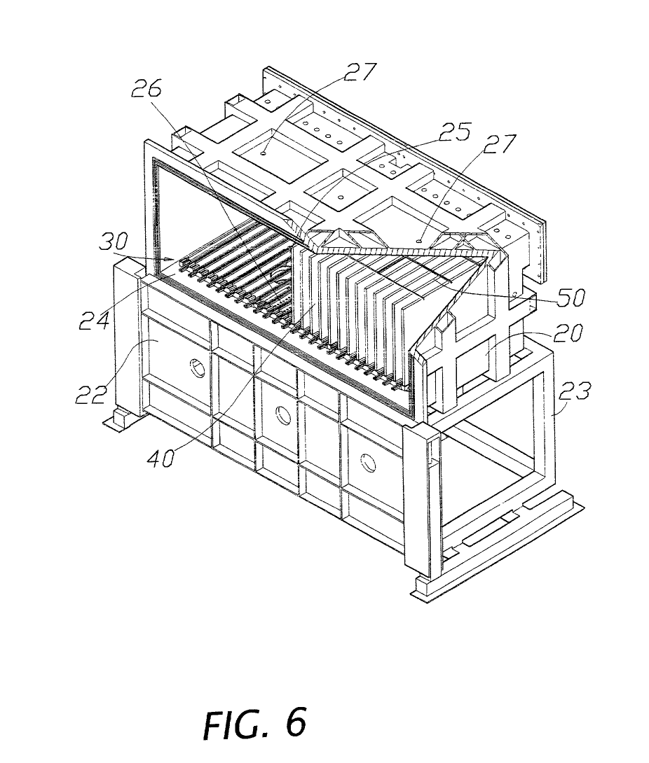

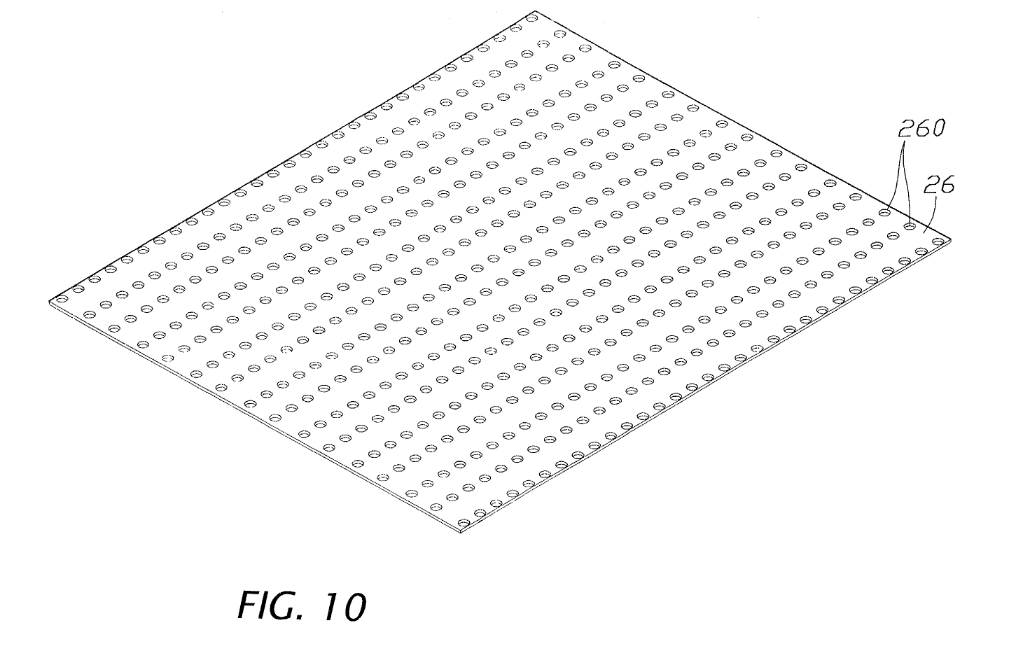

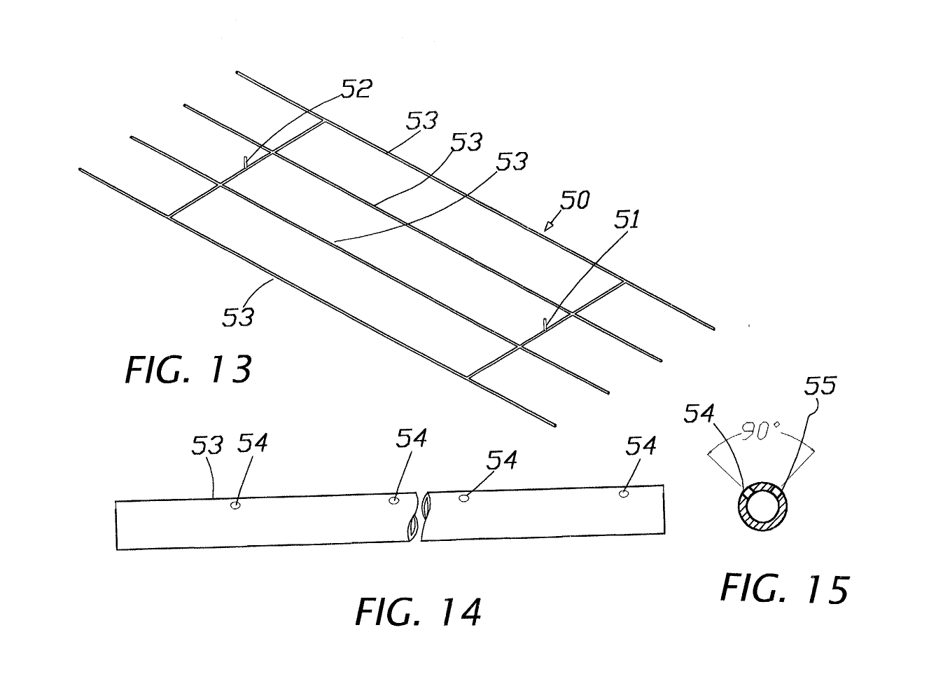

As shown in FIGS. 5 and 6, before a sample holder of the samples to be processed is moved in, the vacuum chamber 20 is provided therein on the bottom surface 24 thereof with a pumping port 25, and an array pumping plate 26 with a lot of holes is mounted on the bottom surface 24 (as shown in FIG. 10). An electrode holder 30 is provided on the array pumping plate 26 on which a plurality of electrode plates 40 are separately mounted thereon in a line; and a gasway device 50 is provided in the upper position of the vacuum chamber 20 (as shown in FIGS. 6 and 13).

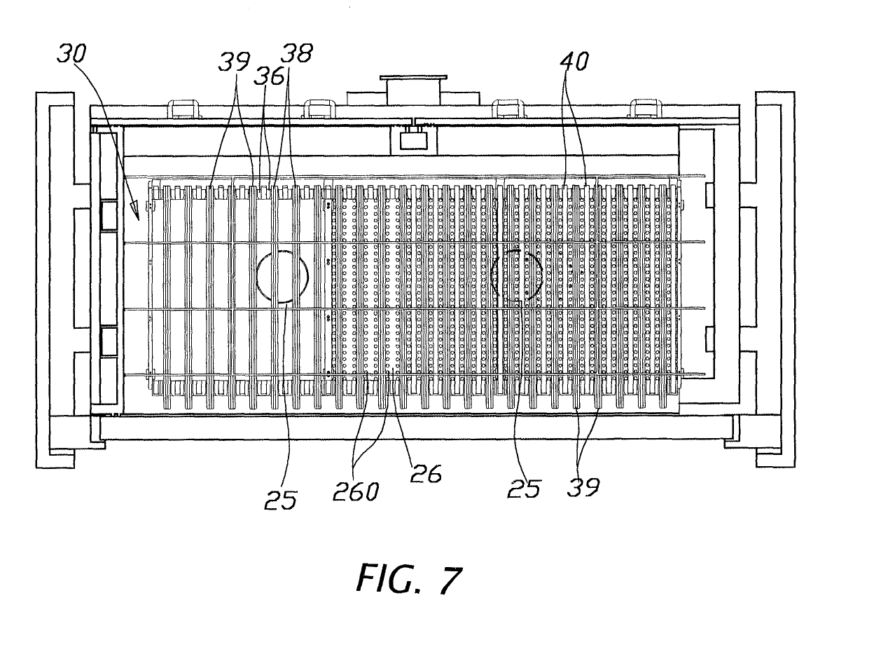

The pumping port 25 on the bottom surface 24 in the vacuum chamber 20 is the main air flow way in the vacuum chamber 20 for pumping to form a vacuum. In order to meet the requirement of uniformity of gas flow, it is preferable that two gas extracting ports 25 are provided (as shown in FIG. 7), so that the gas extracting ports 25 can be located on the rear inner wall and at the positions equidistantly from the two lateral walls respectively. The array pumping plate 26 on the gas extracting ports 25 are provided with a lot of holes 260 arranged in an array as shown in FIG. 10.

The gas extracting ports 25 in the vacuum chamber 20 provided with the holes 260 arranged in the array pumping plate 26 through which the gas is pumped can lower the non-uniformity of gas flow. The principle that the array pumping plate 26 is designed is that the holes 260 must be arranged exactly beneath the sample holder, the positions of the holes 260 shall be between every electrode plate 40 and every slide rail for the sample holder 60 as well as every slide guider for the electrode holder30. Diameter of each hole 260 must be suitable, too small diameter will impede the path of the gas flow and generate disturbance at the bottom of the vacuum chamber 20 and the electrode plates 40; too large diameter will make the gas flow rapidly through the holes 260, and is unable to control the path of the gas flow. The gas flow may flush back by collision against the bottom of the vacuum chamber 20 and gets back to the area near the bottom of the electrode plates 40 through the larger holes, and induces once more disturbance to make non-uniform flow.

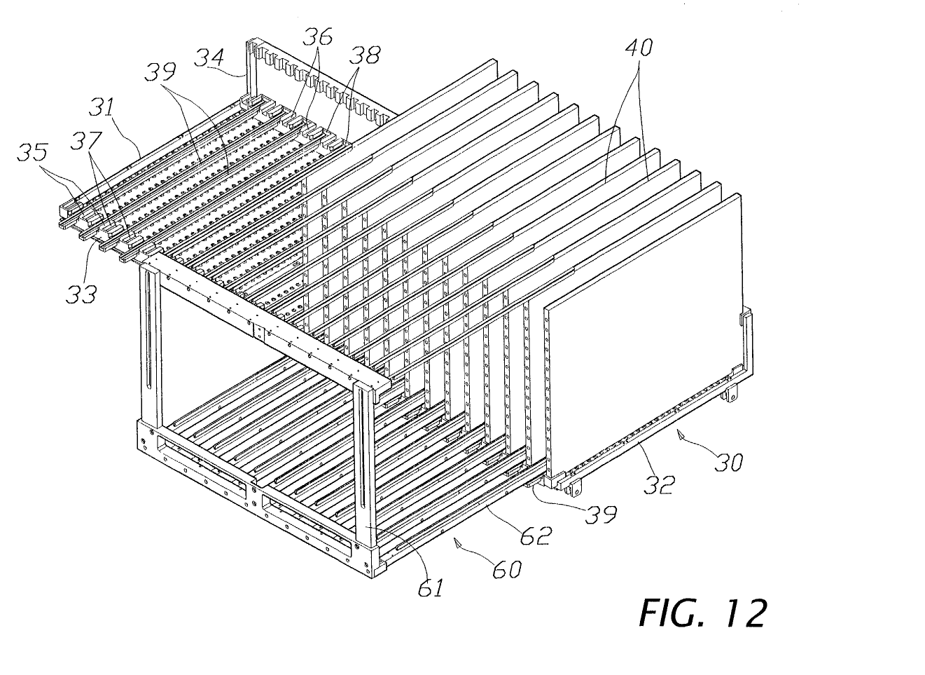

As shown in FIGS. 5 and 12, the electrode holder30 provided on the inner bottom of the vacuum chamber 20 primarily is composed of two lateral supporting frame sides 31, 32 connected with a front supporting frame side 33 and a rear supporting frame side 34. The front supporting frame side 33 is provided with a plurality of mutually spaced clamping seats 35 disposed in a line, the rear supporting frame side 34 is also provided with a plurality of mutually spaced clamping seats 36 similar to the clamping seats 35. The spaces between every two clamping seats 35 of the front supporting frame side 33 and a plurality of grooves 38 provided between every two clamping seats 36 of the rear supporting frame side 34 as shown in FIG. 12 can be put therein each with a slide guider 39. The spaces between every two clamping seats 35 of the front supporting frame side 33 form clamping slots 37, the electrode plates 40 are inserted in the clamping slots 37 formed respectively between every two clamping seats 35 of the front supporting frame side 33 and in the clamping seats 36 of the rear supporting frame side 34.

The pulse-type D.C. power source of the present invention makes excitation of gas in the vacuum chamber 20 to become ionic gas in the state of plasma by means of the abovementioned electrode plates 40 in a line, thereby, in designing the electrode plates 40, it at least needs that:

(1) The area of an electrode plate 40 must be larger than that of a sample, this is primarily because that the electrode plate 40 will normally have different plasma density respectively on the electrode plate 40 itself or on the edges thereof and even in the areas nearby the edges. The samples must be kept away from the edges of the electrode plates 40, this is primarily because that the edge effect induced on the frame portions of the electrode plates 40 by the electric field is not uniform, thus uniformity of the whole treatment will be influenced. And this is why the effective treating area of the processing apparatus of the present invention is at least 10% larger than that of a sample, and influence can thus be reduced.

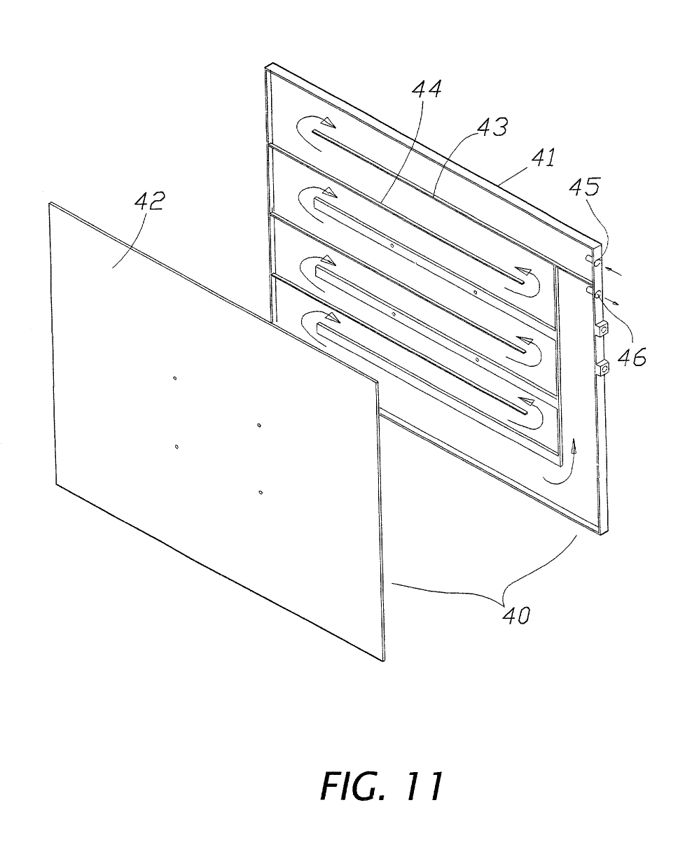

(2) When the electrode plates 40 are fed with a pulse-type D.C. power source to generate plasma, the ionic gas of the plasma will be subjected to the influence of the electric field to bombard the surfaces of the electrode plates 40. Surface temperature of the electrode plates 40 will be raised gradually during energy transformation from kinetic energy to thermal energy. If the surface temperature of the electrode plates 40 can not be lowered (or controlled) effectively, not only the impedance of the electrode plates 40 will be increased to influence stability of the plasma, but also the sample will be heated indirectly by radiating. Once control of temperature fails, the epoxy resin material in the PCB will be melted by heat to destroy lamination of the entire PCB sample. Thereby, the electrode plates 40 are given with water cooling device. As depicted in FIG. 11, wherein, a preferred embodiment of electrode plate 40 is shown being comprised of a main body 41 and a cover plate 42 which are sealed and leakage-proof. A plurality of longer and shorter elongate members 43, 44 are alternately arranged and mutually spaced on the main body 41 to form a circuitous water cooling flow way with a cooling water inlet 46 and an outlet 45, so that cooling water can be fed in through the inlet 46 and flow out of the outlet 45 after cooling by circuitous flowing. By such a water cooling mode, temperature of the electrode plates 40 can be controlled under 50° C., thus the plasma is maintained stable.

(3) Designing of the electrode plates 40 is based on the principle of floating voltage; all the mutually parallel electrode plates 40 on the electrode holder 30 are insulated from the ground with material Teflon in advance, then the electrode plates 40 are alternately arranged parallelly, those electrode plates 40 of either of the two polarities are respectively arranged to have between every two of them an electrode plate 40 of the other polarity; in this way, two groups of electrode plates 40 are formed and are parallelly connected with each other. The two groups of electrode plates 40 are respectively connected with the two electrode output ends of the pulse-type D.C. power supply. The maximum voltage difference between every two neighboring electrode plates 40 is 2000 volts. The positive and negative polarities are controlled by polarity switching of the pulse-type D.C. power supply, so that the plasma generated is bound in each couple of electrode plates 40. The mutually parallel electrode plates 40 are designed to have modeling of plane plates, primarily for the purpose of having a uniform electric field between every couple of parallel electrode plates 40 to effectively control motions of the plasma ions and electrons. Therefore, the PCBs' between every couple of electrode plates 40 can have a most uniform electric field, and quality of the process can be ensured.

By virtue that the vacuum chamber 20 must be of a quite large volume, in addition to control of the direction of gas pumping to lead the gas to the small holes, for uniform distribution of the gas in the vacuum chamber 20, the gas inlet system of the present invention precisely controls the volume of gas flow with a mass flow controller as shown in FIGS. 6 and 13-15 to maintain the concentration of the reaction gas. In this preferred embodiment, two gas inlets 27 are provided to uniformly lead in the gas (referring to FIG. 6), these gas inlets 27 respectively lead the gas (such as the reaction gas) in the vacuum chamber 20 to everywhere on the upper position of the vacuum chamber 20 with upright pipes 51, 52 of the gasway device 50. The gasway device 50 shown is one with multiple holes. There are totally four sets of gasway pipes 53 each with two lines of gas exhausting holes 54, 55, each line of gas exhausting holes 54 are oriented perpendicular to the line of gas exhausting holes 55. The diameters of the outlets of the external two sets of gasway pipes 53 are smaller than those of the middle gasway pipes 53. This is for the purpose of increasing the amount of the gas flow by arranging that the two middle ones are the main outlet areas and the two outside ones are the auxiliary outlet areas.

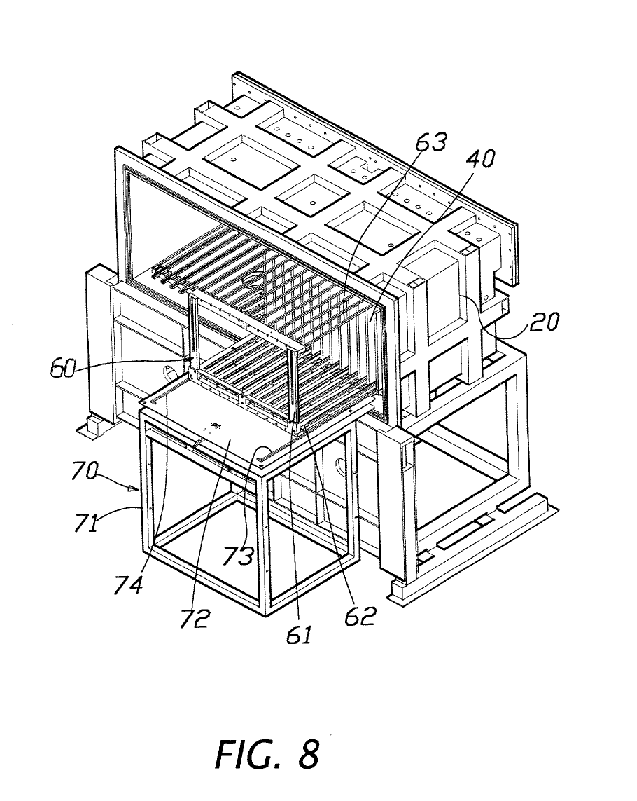

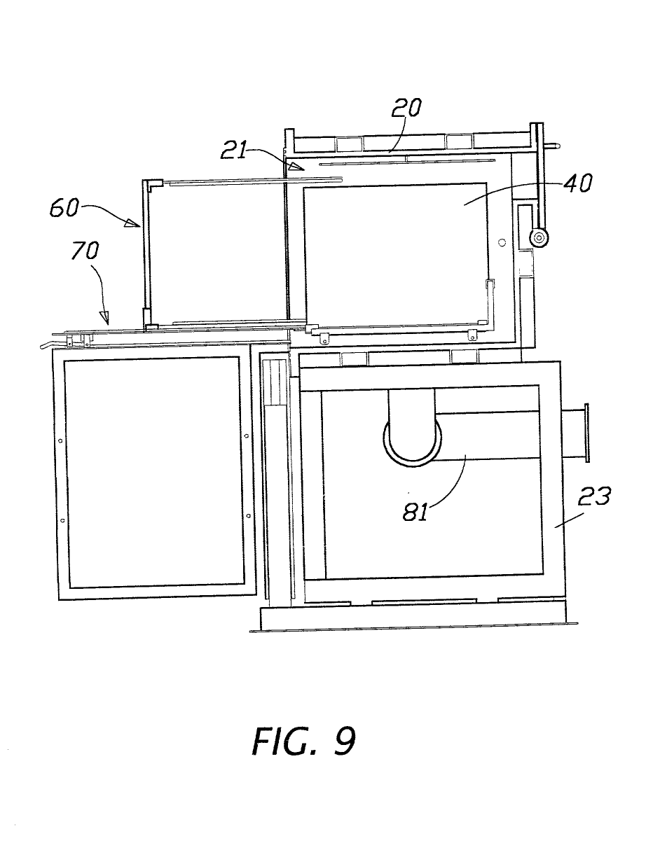

In the present invention as shown in FIGS. 8 and 12, the present invention is provided at least with a sample holder 60 which can be pushed into the vacuum chamber 20, and is provided with a wheeled device 70 for moving the sample holder 60. In this embodiment, the sample holder 60 holding samples in the mode of inserting is provided at the bottom of the front frame 61 thereof with a plurality of lined slide rails 62 which are preferably provided on the lower ends thereof with wheels for easy pushing in of the sample holder 60 with the slide rails 62 aligned with the slide guiders 39 of the electrode holder30. A plurality of mutually parallel rods 63 are provided respectively above the slide rails 62 and their up facing clamping grooves, the rods 63 can be provided with down facing slide grooves therein for insertion clamping of the rigid-type printed circuit boards to be processed. After the whole sample holder 60 is pushed into the vacuum chamber 20, the printed circuit boards are located respectively between every two electrode plates 40 without contacting therewith, to be ready for the operation of desmearing.

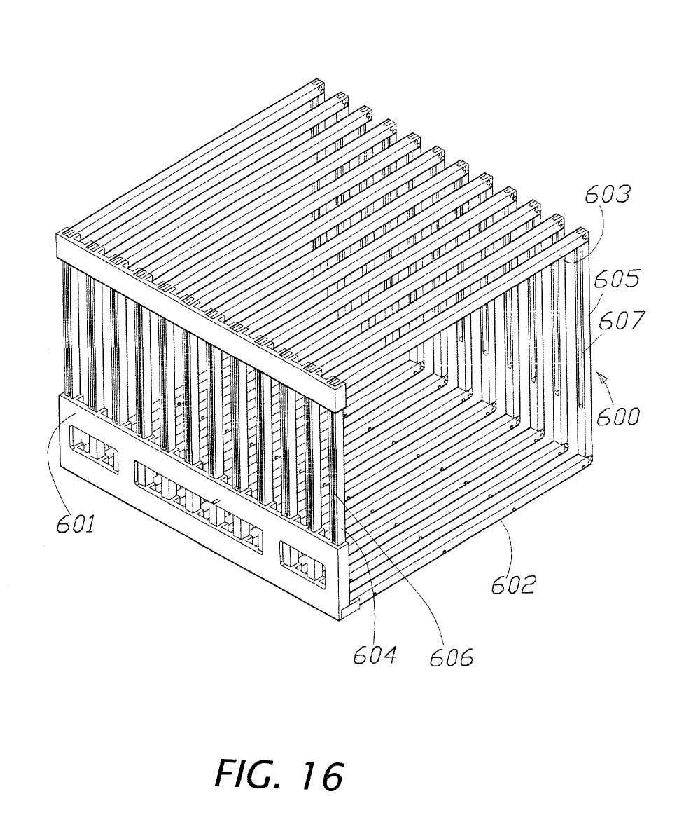

The sample holder 60 can be held in the way of clamping, as shown in FIG. 16, in addition to the above stated insertion mode to simultaneously suit various flexible-type PCBs'. In this embodiment of hanging mode, a sample holder 600 is connected on the front frame 601 thereof with a plurality of lower slide rails 602 and upper mutually parallel rods 603, the latter members are respectively connected with connecting rods 604, 605. The connecting rods 604, 605 are respectively provided with hollow grooves 606, 607 for up and down movement of flexible-type printed circuit boards hung between every two parallel rods 603.

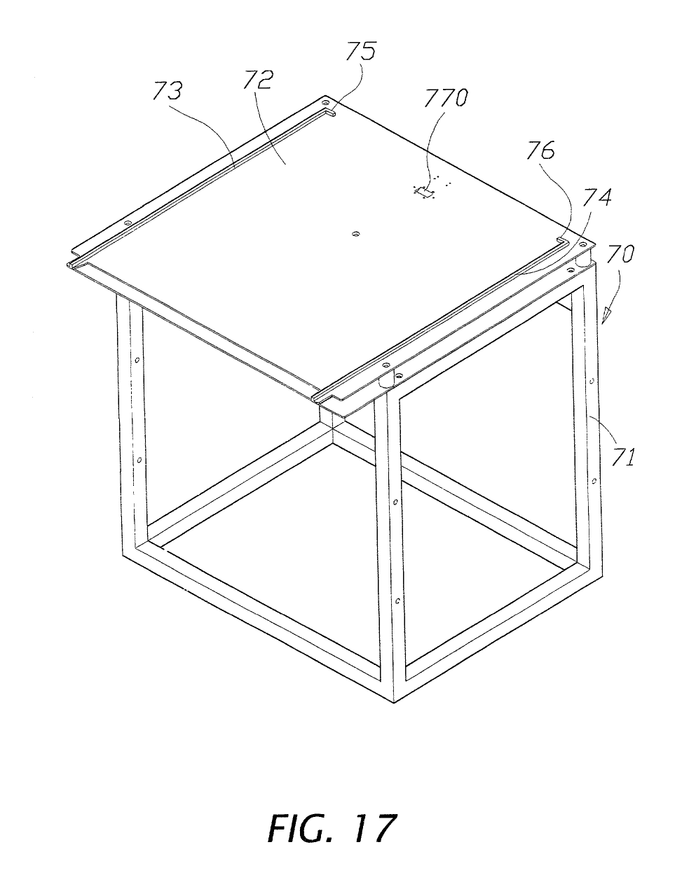

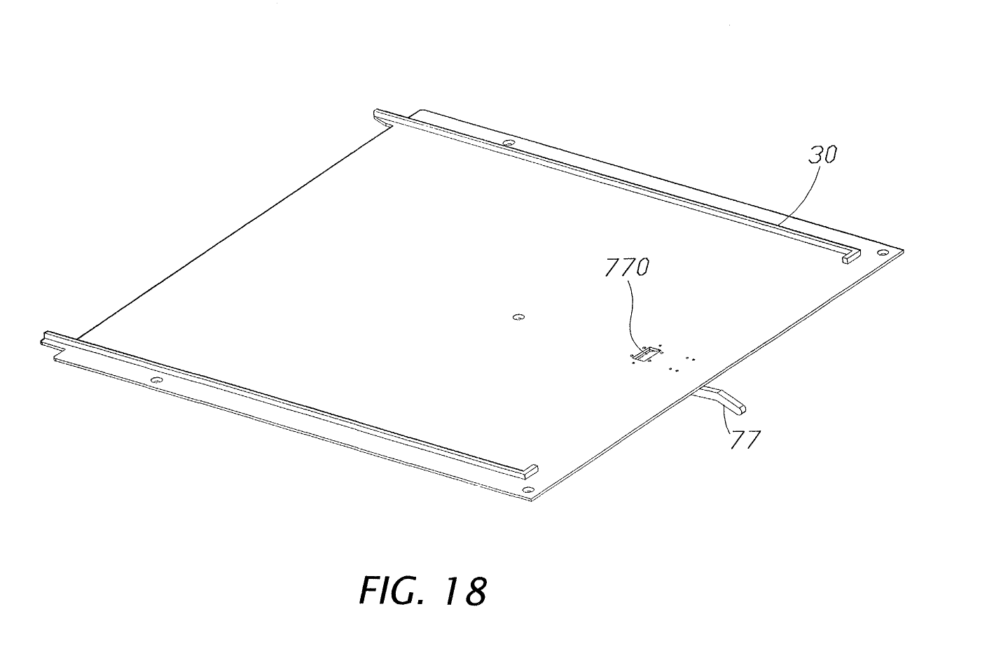

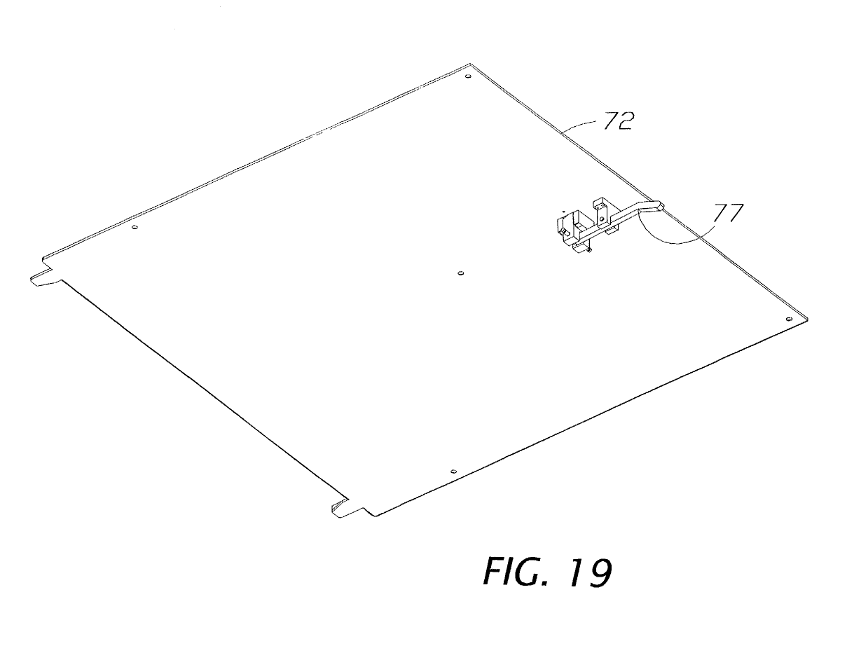

Referring to FIGS. 8 and 17-19, a preferred embodiment of wheeled device 70 is depicted here, wherein, supporting posts 71 of the height in coincidence with that of the access 21 in the front of the vacuum chamber 20 are provided, the supporting posts 71 are provided on the tops thereof with a supporting plate 72 which is provided on the top surface thereof with two framing strips 73, 74 matching the width of the sample holder 60. The framing strips 73, 74 are both opened at one end for access of the sample holder 60; while the other end of both of them is provided with a positioning folding edge 75 (76) to limit the largest stroke of the sample holder 60.

In favor of positioning of the sample holder 60, the supporting plate 72 of the wheeled device 70 is provided with a movably pivotal elastic hooking rod 77 near the rear end thereof, the hooking rod 77 is pivotally connected to control a hooking portion 770 thereof protruding out of the surface of the supporting plate 72 as in the normal state of it to hook a lower edge of the sample holder 60, or to release the sample holder 60.

In order to get an object of reducing weight, the sample holder 60 is preferably made of aluminum alloy, after the sample holder 60 is pushed into the vacuum chamber 20, the electrode plates 40 do not contact with one another and are insulated not to contact the ground. The abovementioned holes 260 of the array pumping plate 26 shall be between every electrode plate 40 and every slide rail 62 for the sample holder 60 as well as every slide guider 39 for the electrode holder30. As a result of test, diameter of each of the holes 260 is most preferably 2/3 of the distance from an electrode plate 40 to its neighboring slide rail 62 in order to get the best uniformity.

The present invention uses the above stated apparatus including the pulse-type D.C. power supply as the energy source to generate plasma, and the electric field thereof is controlled to control motions of the plasma ions and electrons by providing high relative voltage difference. The pulse generator providing the function of output switching between the positive and the negative polarities can have a higher frequency of 50 KHz or even higher. Such kind of power source used presently is widely applied for the processes of vacuum sputtering coating and semiconductor coating and etching. However, the present invention is the first one to apply this technology to the process of desmearing for plasma on PCBs'.

Such kind of power source is advantageous in that:

(1) When the relative voltage difference between the positive and the negative polarities is high up to 2000 volts, the largest output power 20 KW can provide the largest transient accelerating kinetic energy for the ions and electrons in the plasma gas to increase the reacting rate of the plasma.

(2) Motions of the plasma ions and electrons are controlled by the pulse-type electric field; the positive and the negative electric charges can be changed in pursuance of the direction of the electric field to move in mutual contrary directions. Thereby, the electric field generated by the power source of the present invention can directly control motions of the granules with electric charges. This is different from a radio frequency or a microwave system for the same object, the latter shall both add an additional bias-voltage device.

(3) The energy from the power supply not only can be put out in the mode of uni-polar pulse (positive or negative) to form a single directional electric field among the electrode plates; or can be put out alternately in the mode of bi-polar pulse to form a bi-directional electric field to change the directions of motions of the granules with electric charges.

(4) The pulse control parameters of the power supply, including: output voltage, output electric current, output time of energy and shutting time of energy, can all be individually set, they are expressed respectively by tₒₙ+ (output time of the positive voltage), tₒₙ− (output time of the negative voltage), t_{off}+ (shutting time of the positive voltage), t_{off}− (shutting time of the negative voltage). The shortest control time is 5 microseconds, the longest control time is 999 seconds, i.e., the output frequency is 0-50 KHz.

(5) During the generating process of plasma, by limiting of the material of the electrode plates, the system environment and the conditions of production etc., arcing will present frequently during the process, magnitude of the arc will change in pursuance of the conditions of production. If the current of the arc is overly large, the following two cases may occur:

a. the power supply itself may be damaged;

b. the surfaces of the electrode plates and the samples may be damaged.

In order to avoid the above stated cases, the power supply shall have a protecting device against overloading of the current of the arc; the device has a function of automatic cutting which can adjust the current of the arc acceptable by the system or the process. When the current of the arc is over the set value, the power supply will automatically stop outputting energy, the energy can only be put out once the stopping duration is long enough to the set delay time, thereby the function of protection can be achieved.

(6) The t_{off}+ and the t_{off}− in time setting are times of stopping outputting, these parameters are very important to the etching time on the side walls of the holes of the PCBs'. If t_{off} is zero, the reacting ions will forward following the direction of the electric field. However, when t_{off} has a set value, the power source does not have energy output, this means no electric field is generated; the reacting ions will not be influenced by the electric field. Now the reacting ions will move toward all directions by collision of themselves to induce chemical reaction with the side walls of the holes, and the desired etching effect can thus be obtained. Therefore, controlling the time t_{off} can control the degree of etching. Besides, duration of t_{off} can influence the number of the accumulated electric charges on the surfaces of the electrode plates. If t_{off} is insufficient, it will make long time accumulation of electric charges on the surfaces of the electrode plates the charges are unable to be released. When electric charges accumulate to a certain degree, they are subjected to arcing, this will largely influence the effect of the process and the life of the electrode plates.

(7) By the fact that plasma is generated in the area between two electrodes, all energy can only be accumulated on the samples between every two electrodes, in addition to chemical reaction, the ions collide the surfaces of the samples to transform the kinetic energy into thermal energy to directly heat the surfaces of the samples and increase flexibility and kinetic energy of the high molecular chains in the samples to thereby increase the speed of etching. This is the most effective heating mode without adding an additional heat source externally, the rate of heating can make the temperature of the surface of the sample become 127° C. within one minute from the room temperature. The rate of such mode is faster than that of the general radio frequency or microwave plasma source. And more, the energy of the plasma is concentrated in the area between every two electrodes, this is not like the case of the radio frequency plasma which may induce plasma coupling with any grounded area; particularly, the vacuum chamber generally is provided with a grounding device, so that under long time operation of the radio frequency or microwave plasma system, temperature of the vacuum chamber proper will gradually increase to the degree that can scald a hand. This is why the plasma can not be effectively concentrated in the reaction area, and energy in the reaction area of the radio frequency or microwave plasma generally is much smaller in amount than that expected.

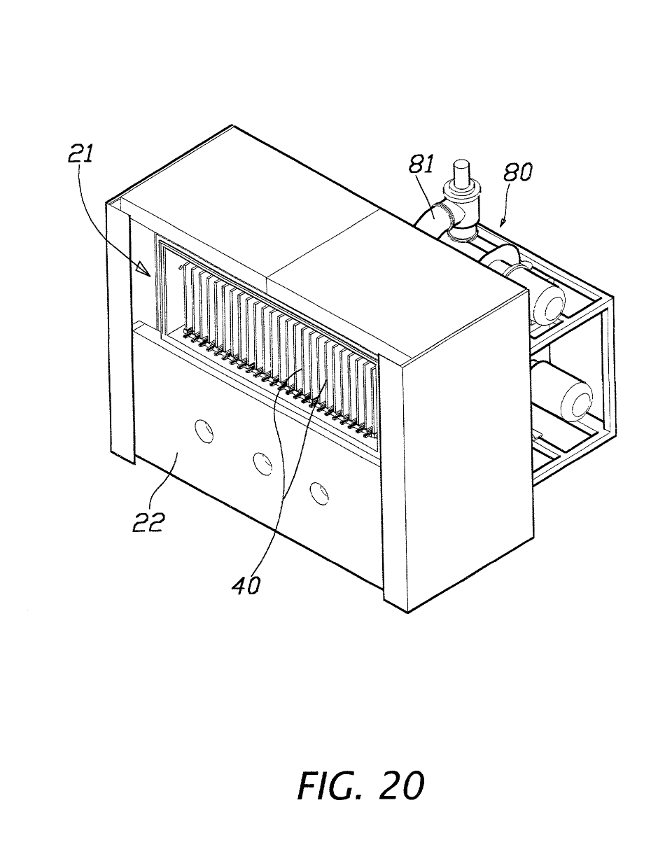

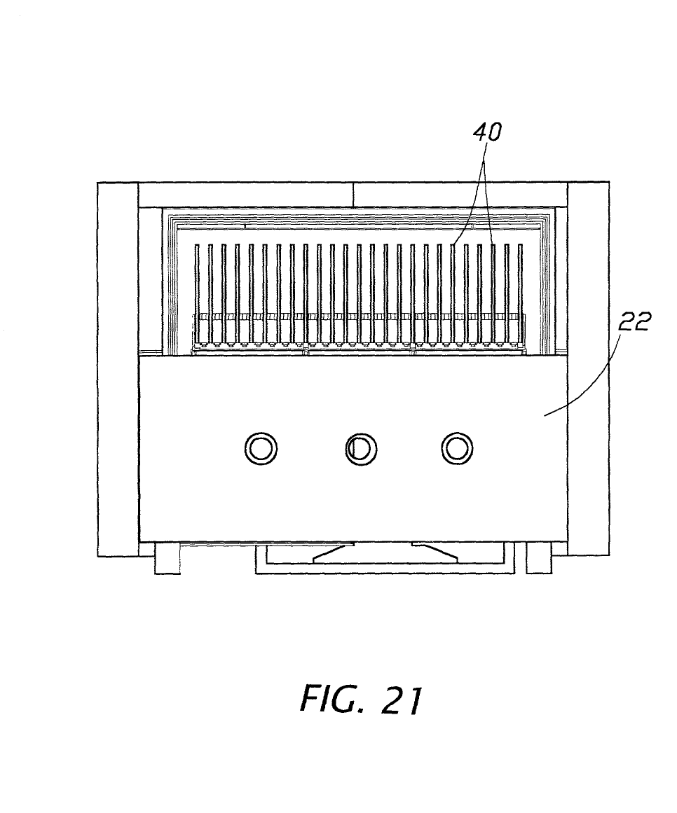

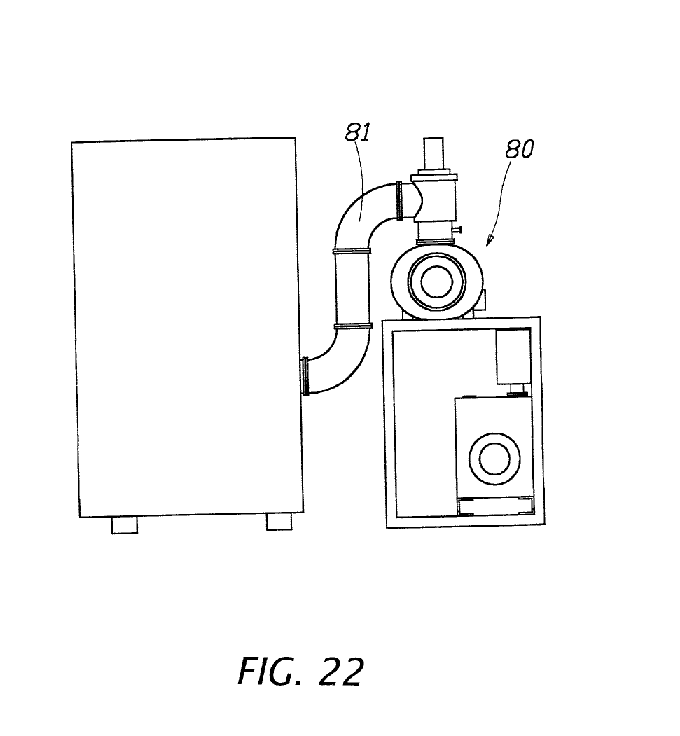

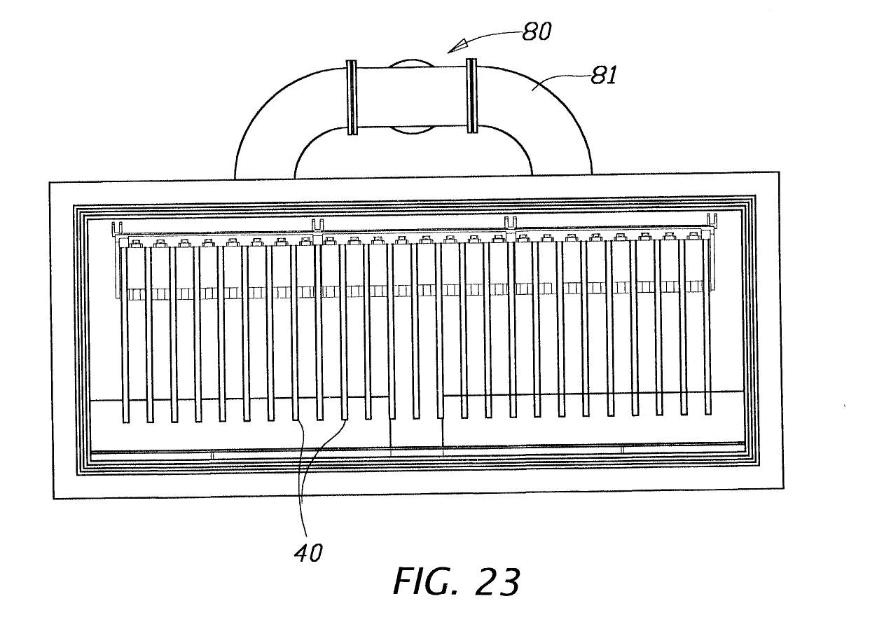

As shown in FIGS. 20-23, in the preferred embodiment of the apparatus of the present invention as stated above, after the apparatus is added with necessary covering members, the rear end of the apparatus is installed with a vacuum pump 80 which basically is comprised of a rotary pump and a Root's pump and can be connected to the aforesaid pumping port 25 via a multi-directional pumping pipe 81.

The process flow of the apparatus of the present invention stated above is as below:

1. PCBs' are placed in the sample holder 60 or 600.

2. The sample holder 60 or 600 is moved into the vacuum chamber 20.

3. It shall be assured that all the PCBs' are not contacted with the electrode plates 40.

4. Shut the door 22, activate the rotary pump, and then activate the Root's pump.

5. Pump down to the base pressure of 30-80 mtorr.

6. Feed in the following reaction gases through the gas inlets 27 and the gasway device 50:

flow of O₂: 200˜1000sccm

flow of CF₄: 10˜500sccm

flow of Ar: 0˜500sccm

reaction pressure: 50˜250mtorr.

O₂ and CF₄ are the principal gases for etching reaction, the two gases can attach by absorbing to the surfaces of smear to make chemical reaction with the smear and to render the polymer to decompose.

Ar has four functions, firstly, it has electric charges and has ionic gas with kinetic energy, when Ar ions collide the surfaces or the walls of holes of a PCB to transform the kinetic energy into thermal energy to heat the PCB, the etching rate will be increased; secondly, Ar ions are heavier, the kinetic energy of it is advantageous for colliding the looser smear to get good removing effect. Thirdly, during reaction of the process, other corrosive byproducts such as HF etc. can be created; they can be carried away by the inert gas Ar to reduce damage to the sample holder or other parts. And fourthly, Ar is used as diluent to reduce the chance of recombination of various ions and electrons having been excited, thereby, life of reaction of the ions can be extended.

7. Activate the pulse-type D.C. power source.

8. Proceed the process under the set conditions, time of treating is 4˜25 minutes.

9. Turn off the D.C. power source and shut off the gas.

10. Keep on pumping till getting the base pressure, the vacuum state is broken by venting to the atmosphere state.

11. Remove the sample (operation is completed).

The present invention can accomplish the desmearing operation for the holes of PCBs' with the above apparatus and by the shortened process flow, its cost of equipment is lower; the present invention thereby has high industrial value.

Having thus described my invention, what I claim as new and desire to be secured by Letters Patent of the United States are:

1. A method for desmearing pulse-type D.C. plasma, said method includes the following steps:
placing a printed circuit board to be processed in a vacuum chamber;
said vacuum chamber is pumped to get a predetermined base pressure;
feeding in reaction gas;
supplying pulse-type D.C. power energy led for electrode plates, an electric field is generated between a positive plate and a negative plate, and ionized gas of said plasma is controlled by said electric field;
controlling the conditions for said process;
reaction is completed;
shutting off said energy and reacting gas;
pumping again and discharging said gas from said vacuum chamber.

2. A method for desmearing pulse-type D.C. plasma as claimed in claim 1, wherein, said electrode plates provided in said vacuum chamber are arranged to be spaced mutually, and are arranged to have between every two of them an electrode plate to be processed, the effective treating area of said electrode plates is at least 10% larger than that of said electrode plate to be processed.

3. A method for desmearing pulse-type D.C. plasma as claimed in claim 1, wherein, said electrode plates are alternately arranged parallelly, those of said electrode plates of either of the two polarities are respectively arranged to have between every two of them an electrode plate of the other polarity; in this way, two groups of said electrode plates are formed and are parallelly connected with each other and respectively connected with the two electrode output ends of said power supply.

4. A method for desmearing pulse-type D.C. plasma as claimed in claim 1, wherein, said step of pumping down gets a base pressure of 30-80 mtorr.

5. A method for desmearing pulse-type D.C. plasma as claimed in claim 1, wherein, said react ion gas flow include:
flow of O₂: 200˜1000sccm
flow of CF₄: 10˜500sccm
flow of Ar: 0˜500sccm
with a reaction pressure: 50˜250mtorr.

6. A method for desmearing pulse-type D.C. plasma as claimed in claim 1, wherein, every two of said neighboring electrode plates are adapted to generating a relative voltage difference up to 2000 volts.

7. An apparatus for desmearing pulse-type D.C. plasma, comprising:
a vacuum chamber of which a front access being controlled for opening/shutting with a movable door;
an electrode holder provided in said vacuum chamber for mounting of a plurality of mutually separated electrode plates thereon in a line;
a pumping system provided to pump gas out of said vacuum chamber;
a gas inlet system provided above said vacuum chamber for feeding in reaction gas to make uniform distribution of said gas in said vacuum chamber by cooperation of said pumping system;
a pulse-type D.C. power supply connecting said electrode plates as an energy source of plasma; and
a sample holder provided to position printed circuit boards to be processed thereon, when said sample holder is pushed into said vacuum chamber in cooperation with said electrode holder, said printed circuit boards to be processed are located respectively between every two of said electrode plates without contacting therewith.

8. An apparatus for desmearing pulse-type D.C. plasma as claimed in claim 7, wherein, said pumping system is connected to a pumping port provided on the bottom of said vacuum chamber via a pumping pipe, and an array pumping plate with a lot of holes is mounted above said pumping port.

9. An apparatus for desmearing pulse-type D.C. plasma as claimed in claim 7, wherein, said gas inlet system includes a gasway device connected to gas inlets provided on the upper portion of said vacuum chamber to lead said gas to everywhere on the upper portion of said vacuum chamber.

10. An apparatus for desmearing pulse-type D.C. plasma as claimed in claim 7, wherein, said electrode plates are alternately arranged, those of said electrode plates of either of the two polarities are respectively arranged to have between every two of them an electrode plate of the other polarity; in this way, two groups of said electrode plates are formed and are parallelly connected with each other and respectively connected with the two electrode output ends of said power supply.

11. An apparatus for desmearing pulse-type D.C. plasma as claimed in claim 10, wherein, said electrode plates each is comprised of a main body and a cover plate which are sealed and leakage-proof; a plurality of longer and shorter elongate members are alternately arranged and mutually spaced on said main body to form a circuitous water cooling flow way with a cooling water inlet and an outlet to feed in cooling water to control temperature of said electrode plates.

12. An apparatus for desmearing pulse-type D.C. plasma as claimed in claim 7, wherein, said electrode holder is composed of two lateral supporting frame sides, a front supporting frame side and a rear supporting frame side connected with said two lateral supporting frame sides, said front supporting frame side is provided with a plurality of mutually spaced clamping seats disposed in a line, said rear supporting frame side is also provided with a plurality of similar and mutually spaced clamping seats; the spaces between every two of said clamping seats of said front supporting frame side and a plurality of grooves provided between every two of said clamping seats of said rear supporting frame side are put therein each with a slide guider for mounting said sample holder, the spaces between every two of said clamping seats of said front supporting frame side form clamping slots, said electrode plates are inserted in said clamping slots formed respectively between every two of said clamping seats of said front supporting frame side and in said clamping seats of said rear supporting frame side.

13. An apparatus for desmearing pulse-type D.C. plasma as claimed in claim 12, wherein, said sample holder holds samples in the mode of inserting and is provided at the bottom of a front frame thereof with a plurality of lined slide rails for pushing in said slide guiders of said electrode holder, a plurality of mutually parallel rods are provided respectively above said slide rails for inserting of rigid-type electric circuit boards to be processed therein.

14. An apparatus for desmearing pulse-type D.C. plasma as claimed in claim 12, wherein, said sample holder is of a clamping mode, and is connected on a front frame thereof with a plurality of lower slide rails for pushing into said slide guiders of said electrode holder; and upper mutually parallel rods are provided respectively above said lower slide rails, said lower slide rails and upper parallel rods are respectively connected with connecting rods, said connecting rods are respectively provided with hollow grooves for clamping flexible-type electric circuit boards to be processed.

15. An apparatus for desmearing pulse-type D.C. plasma as claimed in claim 7, wherein, said sample holder is placed on a wheeled device of the height in coincidence with that of said access in the front of said vacuum chamber.

16. An apparatus for desmearing pulse-type D.C. plasma as claimed in claim 15, wherein, said wheeled device is provided with supporting posts at said access in the front of said vacuum chamber, said supporting posts are provided on the tops thereof with a supporting plate which is provided on the top surface thereof with framing strips matching the width of said sample holder, said framing strips are both provided with a positioning folding edge, an elastic hooking rod is provided near said positioning folding edge to position or release said sample holder.

17. An apparatus for desmearing pulse-type D.C. plasma as claimed in claim 8, wherein, said array pumping plate having a lot of holes thereof located between every of said electrode plates and every of said slide rails for said sample holder as well as every of said slide guiders for said electrode holder.

18. An apparatus for desmearing pulse-type D.C. plasma as claimed in claim 17, wherein, said array pumping plate with a lot of holes of which the diameters each is 2/3 of the distance from a electrode plate to its neighboring slide rail of said sample holder.

19. An apparatus for desmearing pulse-type D.C. plasma as claimed in claim 7, wherein, the effective treating area of any of said electrode plates is at least 10% larger than that of a sample.
